(19) United States
(12) Patent Application Publication
(10) Pub. No.: US 2026/0152232 A1
(43) Pub. Date: Jun. 4, 2026

(54) SYSTEM FOR POSITIONING A REVERSING VEHICLE

(71) Applicant: Hesion Sciences, Inc., Irvine, CA (US)

(72) Inventors: Charles Anthony Camell, Irvine, CA (US); John Alvey, Yorba Linda, CA (US)

(21) Appl. No.: 19/408,151

(22) Filed: Dec. 3, 2025

Related U.S. Application Data
(60) Provisional application No. 63/727,391, filed on Dec. 3, 2024.

(51) Int. Cl. B62D 15/02; G08G 1/16

(52) U.S. Cl. CPC B62D 15/028; G08G 1/168

(57) ABSTRACT

A vehicle positioning system is provided to assist operators of large vehicles, such as heavy-duty commercial vehicles, including machinery, with backing into designated spaces. The vehicle positioning system of the present invention assists operators with positioning their vehicles in a target location. The vehicle positioning system includes a sensor array having at least three sensors, each capable of sweeping, tilting, remaining stationary, or operating in any combination of such movements to capture data from the area in and around a target location. Once a vehicle approaches the area being monitored by the sensors, the sensors begin to capture data regarding the angle, distance and boundaries of the approaching vehicle. The vehicle positioning system then processes the captured data and generates graphics, that can be used as messaging to the operator, that notifies the operator of the position of the vehicle relative to the target zone. As the vehicle approaches the target location, the graphics may be adjusted to allow the operator of the vehicle to determine the distance, and speed, and positioning of the vehicle relative to the target location and adjust the position and speed of the vehicle as needed.

### RELATED APPLICATIONS

This application claims the benefit under 35 U.S.C. § 119(e) of U.S. Provisional Patent Application Ser. No. 63/727,391, filed on Dec. 3, 2024, titled “SYSTEM FOR POSITIONING A REVERSING VEHICLE,” the entire contents of which are incorporated by reference herein.

### FIELD OF THE INVENTION

This invention relates to a system for assisting a vehicle operator with positioning a vehicle into a specific space when operating the vehicle in reverse.

### BACKGROUND

Parking assist systems are known to help vehicle operators position themselves in parking spaces and while parallel parking. Most known parking assist systems are for passenger vehicles and use sensors located on or integrated into the vehicle itself. With the advent of autonomous driving systems, an increasing number of sensors are being used on passenger vehicles to control the position of the vehicle, many of which control the vehicle's steering system.

Current vehicle parking systems have done little to assist heavy-duty commercial vehicles (e.g., semi-trucks), including articulated vehicles and vehicles pulling trailers, tanks, or mixers, to properly align themselves into specified spaces. For vehicles transporting materials or goods, many vehicle operators are required to operate the vehicle in reverse to position the vehicle into a specific location for loading and/or unloading. Often, vehicles need to be in a precise location to receive or unload goods, and/or to accommodate more than one vehicle side-by-side. Precision can be very important in aligning vehicles for such purposes.

One example that requires precision in alignment is when a concrete mixing truck needs to be aligned for cleaning. For example, as shown in U.S. Pat. No. 11,090,700, a boom may be inserted into the top hopper of the mixer for cleaning the inside of the mixer. Here, alignment with the boom to be inserted into the hopper is critical.

Such vehicles are commonly equipped with exterior mounted side view mirrors located on both lateral sides of the vehicle. The side view mirrors allow the driver to generally view the exterior side regions of the vehicle. Typical mirror assemblies employ a linear or non-linear convex reflective lens providing a limited field of view to allow the driver to view the nearby side region. While the side mounted mirrors may assist the driver in detecting objects in the adjacent side lanes, particularly prior to performing a lane change maneuver, the side mirrors can be insufficient for vehicles hauling trailers or commercial vehicles with towed trailers, tanks or mixers. Conventional side view mirror assembly alone may be insufficient to adequately monitor the entire side regions as the vehicle turns or as the vehicle attempts to maneuver in reverse into a specified space. With the conventional vehicle mirror assembly, the resulting field of view offered by the mirror does not allow the driver of the vehicle to easily view the entire path of the trailered body, thereby resulting in a trailer-side blind zone. In these situations, vehicle operators frequently make several attempts to get the vehicle into the proper position, especially when the vehicle is required to turn to achieve the desired position. Further, it is not possible to accurately judge the distance between the truck and desired space.

A need therefore exists for a system that efficiently assists a vehicle operator to guide the vehicle into a specific space while operating the vehicle in reverse. In particular, a need exists for a system that directs the vehicle operator into a particular space with precision through computer managed visual signaling,

### SUMMARY

A vehicle positioning system is provided that assists drivers (or operators) of vehicles with positioning and aligning a reversing vehicle into a specific space or location, and in particular, assists drivers with aligning heavy duty commercial vehicles or machinery when reversing into a space. For purposes of this application the term vehicle is meant to encompasses machinery.

The vehicle positioning system of the present invention includes an array of sensors positioned at the end of a vehicle target location into which the vehicle is reversing into. The vehicle positioning system further includes a panel display, positioned to one side of the target location, so that the panel display can be viewed in the sideview mirror on the driver's side of the aligning vehicle. The panel display provides directional indications to the vehicle operator regarding the positioning of the aligning vehicle based upon data received and processed from the array of sensors. The signals provided to the vehicle operator convey information regarding speed, location and alignment to allow the vehicle operator to safely and accurately reverse into a particular space such that the vehicle is properly aligned and positioned in the target location or space.

In one example, the vehicle positioning system includes (a) at least one sensor unit having at least one sensor, where the at least one sensor unit is capable of moving the at least one sensor along both the horizontal and vertical axis of the at least one sensor unit; (b) a panel display for displaying graphics to the vehicle operator regarding the relative position of the vehicle to the target location; and (c) a system unit in communication with the at least one sensor unit and the panel display for providing power to the at least one sensor unit and the panel display both, for controlling the operation of the at least one sensor unit, receiving data from the at least one sensor unit, processing the data from the at least one sensor unit for determining the relative location of the vehicle to the target location and for displaying messaging on the panel display showing the relative location of the vehicle to the target location.

The vehicle positioning system of this example may further include a sensor array, having a least three horizontally aligned sensor units that each include a sensor. The graphics on the panel display may further include directional indications to direct the vehicle operator on the positioning of the aligning vehicle based upon data received and processed from the at least one sensor unit. N The graphics on the panel display may also include information regarding speed of the vehicle and/or the location of the vehicle. Further, the graphics on the panel display may show the position of the vehicle as it moves into a particular space to allow the vehicle operator to safely and accurately reverse the vehicle into the particular space such that the vehicle is properly aligned and positioned in the target location. Additionally, the at least one sensor unit may sweep, tilt, remain stationary, and/or operate in any combination of movements to capture data from an area in and around the target location. The captured data may be processed, and the processed data may generate either or both static or dynamic graphics on panel display. The graphics on the display board may include a warning graphic to notify the vehicle operator that adjustments are required.

A method for assisting a vehicle operator with properly aligning a vehicle within a target location is also provided. The comprising the steps of: (a) providing at least one sensor for detecting a position of an approaching vehicle; (b) providing a display panel for graphically showing the position of the vehicle relative to the target location; (c) defining a detection area for monitoring by the at least one sensor for an approaching vehicle; (d) defining an angle of sight for the at least one sensor to monitor for an approaching vehicle within the detection area; (e) activating the display panel once the at least one sensor detects an approaching vehicle with the detection area; (f) scanning the area around the target location with the at least one sensor to determine the angles, distance and boundaries of the approaching vehicle; (g) displaying a first graphical message on the display panel using the data from the at least one sensor regarding the angles, distance and boundaries of the approaching vehicle to graphically show the location of the vehicle and its trajectory relative to the target location; and (h) continuing to display subsequent graphical messages on the display panel until the vehicle is properly aligned in the target location.

Here, displaying a first graphical message on the display panel may further include display the speed of the vehicle. The at least one sensor may be an an array of sensors. The array of sensors may include at least three sensors capable of sweeping, tilting, remaining stationary, or operating in any combination of movements to capture data from the area in and around the target location for guiding the operator of the vehicle into the target location. The first graphical message on the display panel is either or both static or dynamic. The step of continuing to display subsequent graphical messages on the display panel until the vehicle is properly aligned in the target location includes adjusting the graphical messages on the display panel until the vehicle is properly positioned in the target location. The method may also further include the step of displaying a second graphical message if the at least one sensor detects that the position of the vehicle is too far to the driver's side or the passenger's side of the target location, where the second graphical message is a warning message, and/or where the step of displaying a second graphically message notifies the vehicle operator to reposition the vehicle or provides the warning message if the at least one sensor detects that the position of the vehicle is beyond the target location to direct the operator to move the vehicle forward. Such graphical message may take the form of either graphics or text or a combination of both graphics and text.

In another example, the vehicle position system includes a sensor array having at least three sensors capable of sweeping, tilting, remaining stationary, or operating in any combination of movements to capture data from the area in and around a target location for the vehicle to stop or park. The captured data is processed, and the processed data generates graphics on an illuminated display board. The graphics on the display board may be either static or dynamic. The graphics provide messaging to the operator of the vehicle regarding the vehicle's position as it approaches the target location for stopping and/or parking. As the vehicle approaches the target location, the graphics may be adjusted to allow the operator of the vehicle to determine the distance, speed, and positioning of the vehicle relative to the target location.

If the driver of the vehicle positions the vehicle too far to the driver's side or the passenger's side of the target location, warning graphics may be displayed to the operator to allow the operator to make the necessary adjustments. Further, if the operator positions the vehicle past the target location, the display panel may show the operator has overshot the target location and can direct the operator to move the vehicle forward.

While operating the vehicle, the driver can watch the display to see the vehicle's trajectory into the target location and the operator can adjust the vehicle location to the right or left as the operator watches the display panel through the vehicle's sideview or even rear-view mirror. As the vehicle approaches the target location, the graphics on the panel display inform the operator of the distance between the vehicle and the target location, which allows the driver to adjust the speed of the vehicle to stop the vehicle in correct position.

In yet another example, the vehicle position system for assisting a vehicle operator with properly aligning and positioning a vehicle within a target location may include at least one sensor unit having at least one sensor, where the at least one sensor unit is capable of moving the at least one sensor along both the horizontal and vertical axis of the at least one sensor unit. The system may further includes a panel display for displaying graphics to the vehicle operator regarding the relative position of the vehicle to the target location, and a system unit in communication with the at least one sensor unit and the panel display for providing power to the at least one sensor unit and the panel display both, for controlling the operation of the at least one sensor unit, receiving data from the at least one sensor unit, processing the data from the at least one sensor unit for determining the relative location of the vehicle to the target location and for displaying messaging on the panel display showing the relative location of the vehicle to the target location. Here, the at least one sensor unit may be just one sensor programmed to perform all the functions of an array of sensors.

Other devices, apparatus, systems, methods, features and advantages of the invention are or will become apparent to one with skill in the art upon examination of the following figures and detailed description. It is intended that all such additional systems, methods, features and advantages be included within this description, be within the scope of the invention, and be protected by the accompanying claims.

### DESCRIPTION OF FIGURES

The invention may be better understood by referring to the following figures. The components in the figures are not necessarily to scale, emphasis instead being placed upon illustrating the principles of the invention.

FIG. 1 is a diagram showing a vehicle backing into a designated space equipped with the vehicle positioning system of the present invention.

FIG. 2 illustrates a block diagram of one example of a vehicle positioning system of the present invention.

FIG. 3 illustrates a perspective view of one example of a sensor array of the vehicle positioning system of FIG. 2.

FIG. 4 illustrates a side view of the sensor array of FIG. 2.

FIG. 5 illustrates a front perspective view of one of the sensor arrays of FIG. 2.

FIG. 6 illustrates the sensor array of FIG. 2 with the sensor positioned down and to the left.

FIG. 7 illustrates a perspective view of one example of a control box of the vehicle positioning system of FIG. 2.

FIG. 8 illustrates a perspective view of one example of a display panel of FIG. 2.

FIG. 9 is a flow diagram illustrating one example of an operation of the vehicle positioning system of the present invention.

FIG. 10 illustrates one example of messaging that may be used with the vehicle positioning system of the present invention.

FIG. 11 illustrates one example of messaging that may be used with the vehicle positioning system of the present invention.

FIG. 12 illustrates one example of messaging that may be used with the vehicle positioning system of the present invention.

FIG. 13 illustrates another example of messaging that may be used with the vehicle positioning system of the present invention.

FIG. 14 illustrates yet another example of messaging that may be used with the vehicle positioning system of the present invention.

FIG. 15 illustrates yet another example of messaging that may be used with the vehicle positioning system of the present invention.

FIG. 16 illustrates yet another example of messaging that may be used with the vehicle positioning system of the present invention.

FIG. 17 illustrates yet another example of messaging that may be used with the vehicle positioning system of the present invention.

FIG. 18 illustrates yet another example of messaging that may be used with the vehicle positioning system of the present invention.

FIG. 19 illustrates yet another example of messaging that may be used with the vehicle positioning system of the present invention.

FIG. 20 illustrates yet another example of messaging that may be used with the vehicle positioning system of the present invention.

### DETAILED DESCRIPTION OF INVENTION

The current invention application relates to a vehicle positioning system 100 that assists operators or drivers of vehicles 102 with properly positioning and aligning vehicles 102 when backing into designated or specified spaces 104. The vehicle positioning system 100 of the present invention is particularly useful when a vehicle is being backed into a specified space 104 for purposes of performing a particular task such as loading, unloading payload and/or cleaning containers, tanks and/or mixers, where it is important for the vehicle to park in a target location 105 with the space 104. The present invention is particularly helpful when assisting heavy-duty machines and commercial vehicles (e.g., semi-trucks) 100, including articulated vehicles and vehicles pulling trailers, tanks or mixers, to properly align themselves into a specified space 104. Many vehicle operators are required to operate their vehicles 102 in reverse to position their vehicles 102 into a specific location for loading and/or unloading, and in the case of tanker trucks or mixing trucks, such as cement trucks, cleaning of the transport containers, tanks, and mixers is also often required. Oftentimes, vehicles 102 need to be in a precise location to receive or unload goods or materials and/or to accommodate more than one vehicle side-by-side in a particular location, Accordingly, precision can be very important in aligning vehicles 102 for such purposes and for aligning vehicles 102 side-by-side in particular areas, like docks or cleaning stations.

As will be set forth and described further below, the present invention includes a sensor array 110 in communication with a panel display 130 via a system unit 120. The panel display 130 may also be referred to in this application as a display panel 130. The panel display 130 can be viewed by a vehicle operator in the sideview mirrors or rearview mirrors of the vehicle 102 to assist in aligning the vehicle 102 in a target location 105 within in the specified space 104. Alternatively, or in addition to a panel display 130, the system may be designed to help users align their vehicles 102 using application software installed onboard the vehicle 102 or on an associated personal electronic device with a user display. In this example, information regarding the location, alignment and corrective information of the vehicle 102 typically seen on the panel display 130 may be seen on either or both the panel display 103 and/or onboard display or user display of the personal electronic device. In this manner, the vehicle positioning system 100 may also provide location and alignment information to the vehicle operator on a panel display 130, onboard display or display of a personal electronic device to assist drivers when backing into specified spaces 104.

In this disclosure, all “aspects,” “examples,” “embodiments,” and “implementations” described are considered to be non-limiting and non-exclusive. Accordingly, the fact that a specific “aspect,” “example,” “embodiment,” or “implementation” is explicitly described herein does not exclude other “aspects,” “examples,” “embodiments,” and “implementations” from the scope of the present disclosure even if not explicitly described. In this disclosure, the terms “aspect,” “example,” “embodiment,” and “implementation” are used interchangeably, i.e., are considered to have interchangeable meanings.

In this application, the term “substantially,” “approximately,” or “about,” when modifying a specified numerical value, may be taken to encompass a range of values that include +/−10% of such numerical value. Further, such as “communicate,” and “in . . . communication with,” or “interfaces” or “interfaces with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate or interface with a second component is not intended to exclude the possibility that additional components may be present between, and/or operatively associated or engaged with, the first and second components.

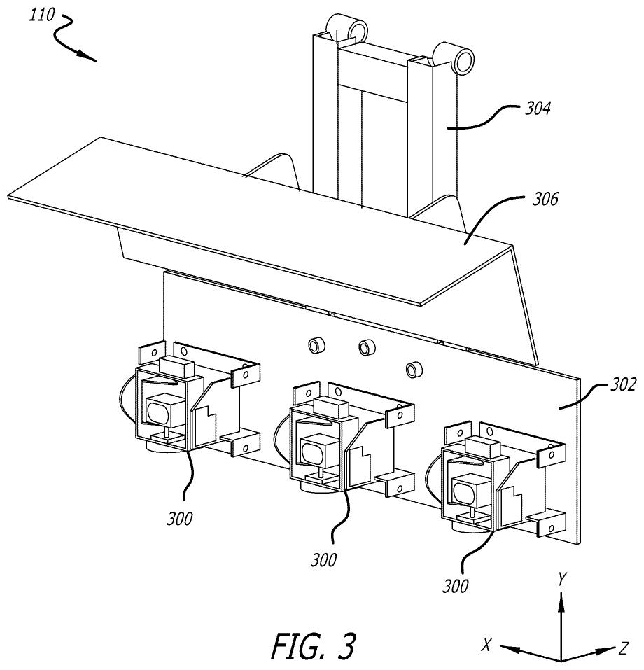

For purposes of reference and description, the components of the vehicle positioning system are considered to have horizontal (x-axis) and vertical device axis (y-axis) and a z-axis, as shown in FIGS. 3, 7 and 8, along which the components of each component of the vehicle positioning system are positioned relative to each other. Terms such as “axial” and “axially” are assumed to refer to the respective axis or any direction or axis parallel to the device axis, unless indicated otherwise or the context dictates otherwise. For convenience, movement relative to a device axis may alternatively encompass movement relative to an axis that is parallel to the device axis that is specifically illustrated in FIGS. 3, 7 and 8 unless the context dictates otherwise. Thus, linear translation “along the device axis z” is not limited to translation directly on (coincident with) the device axis, but also encompasses translation parallel to the device axis z, depending on the context. Similarly, rotation “about the device axis y” also encompasses rotation about an axis that is parallel to the device axis y, depending on the context.

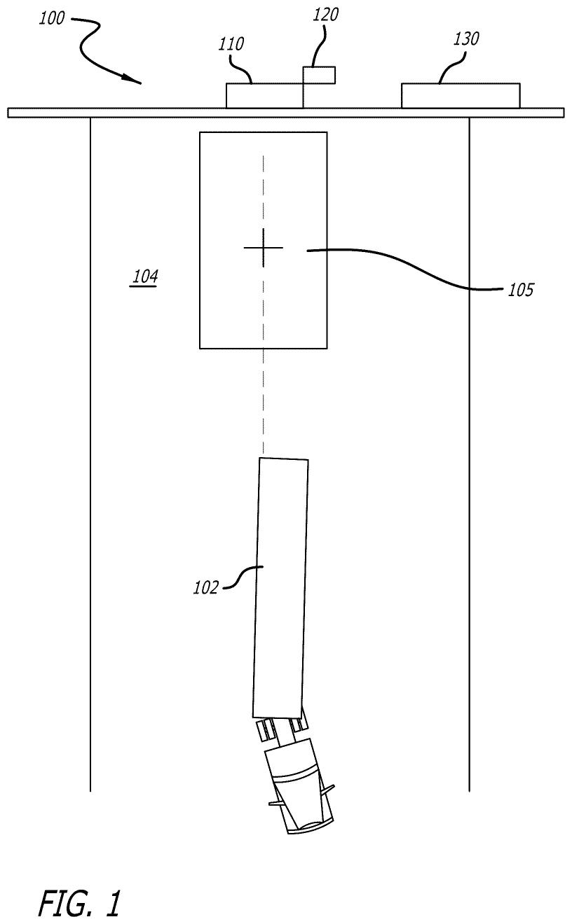

FIG. 1 is a diagram showing a vehicle 102 backing into a designated space 104 equipped with the vehicle positioning system 100 of the present invention. As illustrated in FIG. 1., a heavy-duty commercial vehicle 102 is shown backing into a designated space 104. Here, the operator of vehicle 102 is attempting to align the rear center of vehicle 102 (or the vehicle trailer) with a target 105, which is the center point of the terminating end of the designated space 104. Centrally aligned with the target 105 is a sensor array 110 of the vehicle positioning system 100. To the right of the sensor array 110, when facing the sensor array 110, is a panel display 130 in communication with the sensor array 110 via a system unit 120. Panel display 130 is positioned such that the driver of vehicle 102 can see the panel display 130 clearly in the sideview mirror on the driver's side of the vehicle. Optionally, but not necessary, a second panel display 130 may also be positioned to the left of the sensor array 110 to be viewed from the sideview mirror on the passenger side of vehicle 102.

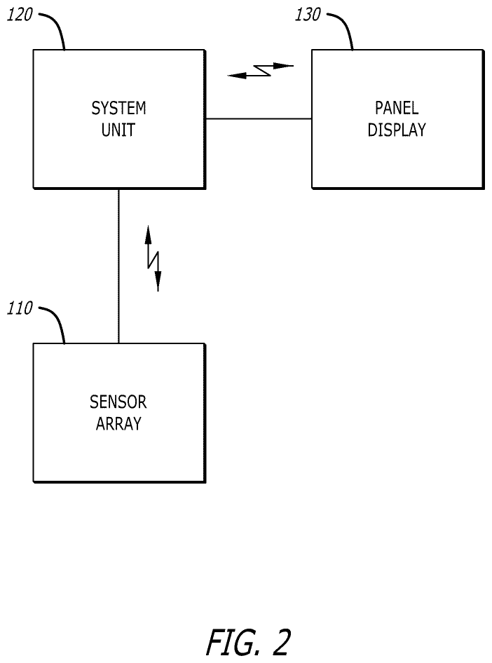

FIG. 2 illustrates a block diagram of one example of a vehicle positioning system 100 of the present invention. As shown in FIG. 2, the vehicle positioning system 100 includes three main components: a sensor array 110, a system unit 120 and a panel display 130. These three system components 110, 120 and 130 may be in communication with one another either wirelessly or wired; however, given the need for real-time responses to the vehicle position detected by the sensory array 110 relative to the target 105, it is preferred that the system be hardwired.

FIG. 3 illustrates a perspective view of one example of a sensor array 110 of the vehicle positioning system 100 of FIG. 2. As shown, the sensory array 110 of the present invention includes at least three sensor unites 300 in horizontal alignment with one another. The sensor units 300 are mounted linearly, in fixed positions, equidistant distance from one another with the center sensor unit 300 forwardly aligned with the center of the target area for vehicle alignment in the designated space 104. In one example, the side sensor units 300 on each side of the center sensor unit 300 are positioned approximately 12″ away from the center sensor unit 300.

Sensor array 110 further includes a particle support panel 302 upon which the sensor units 300 are mounted in horizontal alignment. Positioned just above the support bracket 302 is a weather shield 306 for protecting the sensor units from weather and other environmental conditions that could impact their function in operation. The entire sensor array may be mounted using mounting bracket 304.

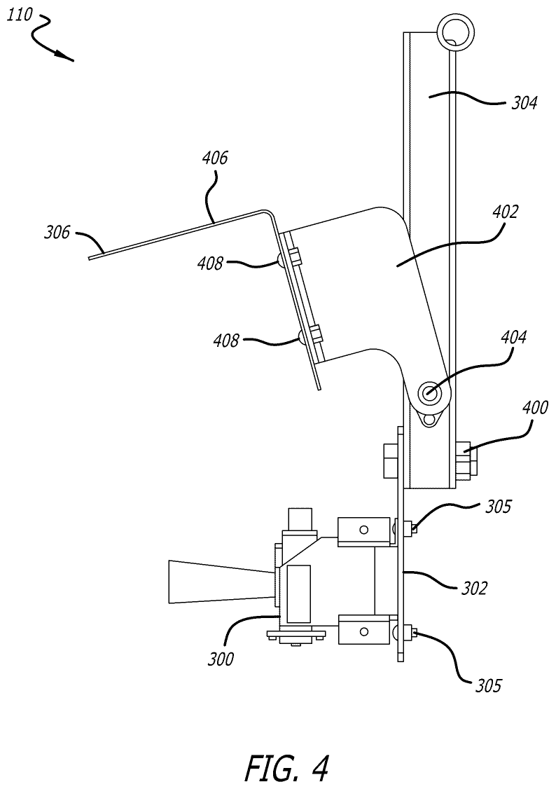

FIG. 4 illustrates a side view of the sensor array 110 of FIG. 2. FIG. 4 shows the mounting of the sensor units 300 on to the support panel 302 using fasteners 305. The support panel is then mounted on to the mounting bracket 304 using fasteners 400. The weather shield 306 may be an L-shaped bracket 406 attached to at least one, but in this example, two pivot arms 402 that pivotally to mounting bracket 304.

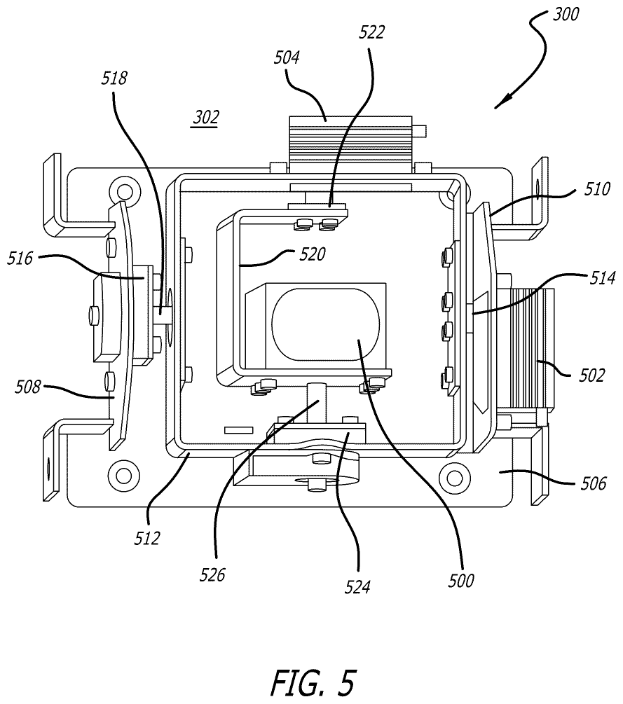

FIG. 5 illustrates a front perspective view of one of the sensor units 300 of FIG. 2. As seen in FIG. 2, senor unit 300 is shown attached to support bracket 302. Sensor unit 300 includes a sensor 500 and a first motor 502 and second motor 504 for controlling the movement of the sensor 500. Sensor unit 300 includes a sensor bracket 506 which mounts the sensor unit 300 to support bracket 302. Sensor bracket 506 includes a first side wall 510 and second side wall 508.

Sensor 500 is affixed to a U bracket 520 which is pivotally connected to a square bracket 510 which surrounds the U bracket 520, and which is pivotally connected to the second side 508 of the sensor bracket 506. As described further below, U bracket 520 pivotally connected at one end to square bracket 510. This pivotal connection allows the U bracket 520 to move about the vertical axis of the sensor unit 300, which in the illustrated orientation allows the U bracket 520 to move right and left.

Square bracket 510 is pivotally connected on one side to either the first or second side wall 510, 508. In this illustrated example, square bracket 520 is pivotally connected to the second side wall 508, which allows the square bracket 510 to rotate about the horizontal axis of the sensor unit 300. In the illustrated orientation, this pivotal connection allows the square bracket 510 to rotate up and down.

To move the square bracket 510, a first motor 502 is connected to the first side wall 510 of the center bracket 506. A horizontal driveshaft 514 extends from the first motor 502 through the first side wall 510 of the sensor bracket 506. The horizontal drive shaft 514 is connected to square bracket 512 and when activated rotates the square bracket 510 about the horizontal axis of the sensor unit 300. This rotation about the horizontal axis of sensor unit 300 is responsible for moving the square bracket 512 up and down. On the side opposing the first motor 502, square bracket 512 is attached to the second side wall 508 by horizontal pivot pin 518 secured to through a horizontal pin bracket 516 is affixed to the second side wall 508. Connection of the horizontal pivot pin 518 through the second side wall 508 via the horizontal pin bracket 516 allows the square bracket 512 to pivotally rotate relative to the second side wall 508.

Similarly, to move the U bracket 520, a second motor 504 is connected to one side of the square bracket 512. Vertical driveshaft 522 extends from the second motor 504 through the square bracket 512 and is affixed to one side of the U bracket 520. This rotation about the vertical axis of sensor unit 300 is responsible for moving the U bracket 520 right and left. Vertical driveshaft 522 when activated rotates the U bracket 520 about the vertical access of the sensor unit 300. On the opposite side of the second motor 502, U bracket 520 is attached to an opposing side of the square bracket 512 five vertical pivot pin 526, which is secured to the square bracket 512 by a vertical pivot pin map 524. Connection of the vertical pivot pin 526 through the square bracket 512 via the vertical pin bracket 524 pivotally leave rotates you bracket 520 relative to the square bracket 510. Through the use of two motors 502, 504, which in this example may be servo motors, sensors 500 can pivot along both the x and y simultaneously to monitor a wide range of area in front of the sensors 500.

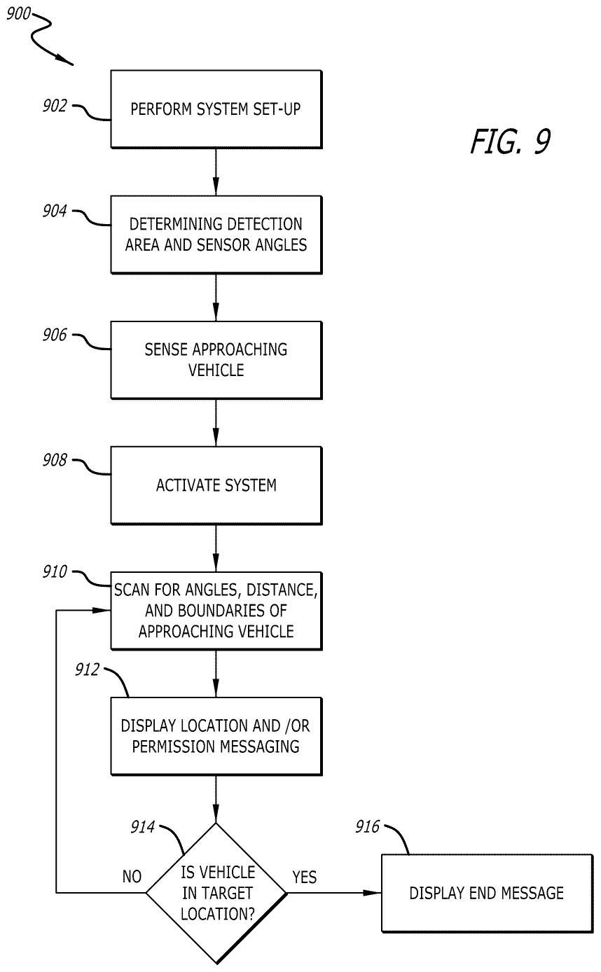

As will be better explained in connection with FIG. 9, the use of at least three sensor units 300 in the sensor array 510, allows the center sensor unit 300 to monitor a vehicles' positioning along the center line, while the right and left sensors 300 in the sensor array 510 are able to monitor the vehicles positioning along right and left trajectory lines. The sensor units 300 are also able to operate to together monitor the areas about the centerline and right and left trajectory lines. Optionally, the center sensor unit 300 may be eliminated, using the left and rights sensors 300 to monitor the vehicles' positioning along the center line.

Sensors 500 may be augmented reality (AR) sensors, such as Light and Ranging (LiDAR) sensors, which emits pulsed laser light and measures its return time, thereby creating a precise 3D rendering of the surveyed area or object. The fundamental workings of a LiDAR sensor require a laser transmitter that emits short pulses of laser light, which bounce off objects in the environment. In one example of an implementation, the LiDAR sensors may be single point sensors; however, it may be possible to use multiple point sensors. A receiver detects the reflected light and measures the time it takes for the light to travel to and from the object, thus determining the distance to the object. This technique, known as time-of-flight (TOF), is one of the LiDAR system variants, alongside frequency-modulated continuous wave (FMCW) and phase shift LiDAR systems.

The use of LiDAR sensors also provides some advantages as they are capable of shining lasers through fog and bright sunlight, where regular lasers fade away in bright sunlight. The LiDAR sensors are also one of the best lasers for bouncing off metal objects and can get reflectivity up to 100 meters away, even in bright daylight. Further, they are accurate at close range, allowing placement of a vehicle up to an inch from their target. While the use of LiDAR sensors provides exceptionally accurate depiction of the environment or target, those skilled in the art will recognize that other sensors using remote-sensing technology, including but not limited to the use of RADAR, may be substituted for the LiDAR sensors without departing form the scope of the invention.

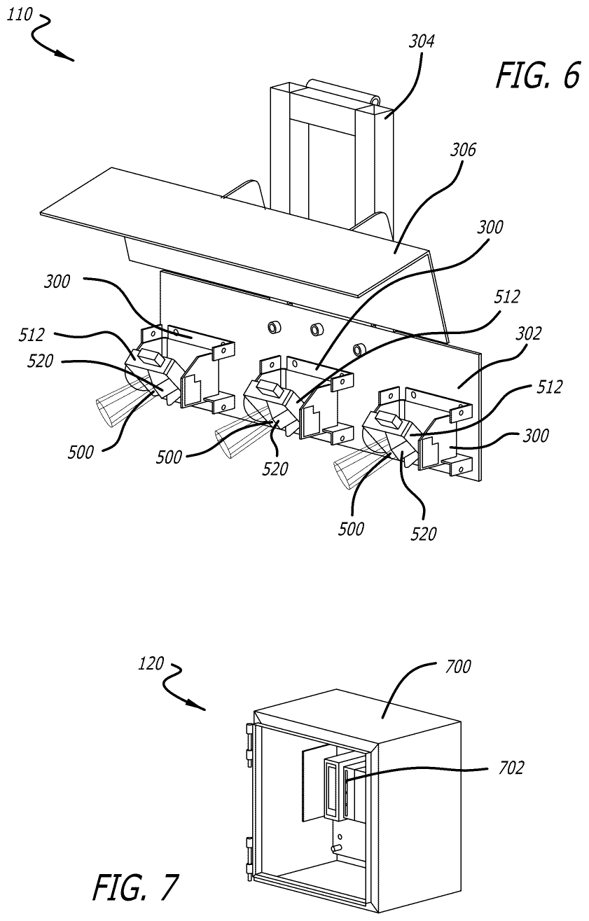

FIG. 6 illustrates the sensor array 110 of FIG. 2 with the sensor unit 300 positioning the sensors 500 down and to the left. As shown in FIG. 6, the U bracket 520 has been rotated to the left (facing the sensor array 110) and the square bracket 512 is pivoted downward, together causing the sensors 500 to face down and to the left. While the current illustration shows all the sensors 500 facing the same direction, those skilled in the art will recognize that each sensor unit 300 can operate either together with the other sensor units 300 or independently from the other sensor units 300. Further, the sensor units 300 can position the sensor 500 in any direction along the x and y axis. For example, the center sensor 500 can remain forward, while the left sensor faces up and to the left and the right sensor 500 is positioned to face down and to the right. Further, the sensors can remain stationary, can move intermittently or can be in continuous motion.

FIG. 7 illustrates a perspective view of one example of a system unit 120 of the vehicle positioning system of FIG. 2. Here the system unit 120 includes a housing 700 for housing the various components of hardware and software necessary to control the operation of the sensor units 300 on sensor array 110, processing the information received from the sensors 500 and produce messaging on the display panel 130 to guide the operator of the vehicle based upon the data collected by the sensors 500. System unit 120 may provide a power source and a circuit board that includes a central processing unit and memory with software programed to control the operation of the sensor array 110 and panel display 130 thorough the processing of data received from the sensors 500.

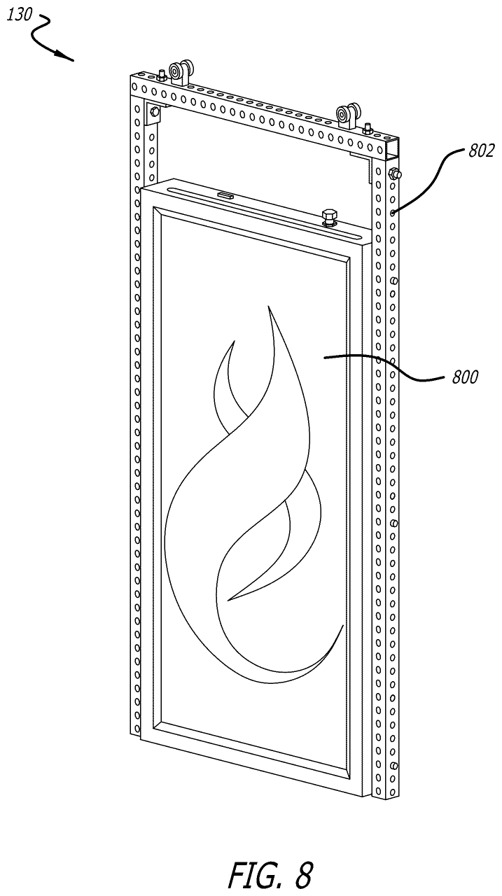

FIG. 8 illustrates a perspective view of one example of a display panel 130 of FIG. 2. Display panel 130 may be any type of display, including LCD, LED or other types of panel. In the illustrated example, the display panel is a pixel LED panel display large enough to be clearly visible by operators of approaching vehicles. For example, the display panel may be several feet long by several feet wide. In one example the display may use superbright multi-colored daylight LEDs in a pattern being 96″ tall and 48″ across. Here, the display panel is surrounded by mounting rails 802 for mounting the display panel 130; however, other known types of mounting system may be used to mount the display panel in an upright and vertical position.

FIG. 9 is a flow diagram illustrating one example operation 900 of the vehicle positioning system 100 of the present invention. In operation, the sensor array 110 is mounted in a position where the center sensor 500 in the sensor array 110 is in line with the centerline of the target location 105 for the vehicle and at height that is able to detect and guide an approaching vehicle 102. When looking at the sensor array 110, the right sensor 500 is primarily responsible for detecting the location of the drivers' side of the vehicle 102 when approaching in reverse and the left sensor 500 is primarily responsible for detecting the location of the passenger's side of the vehicle 102 when approaching in reverse.

Once the sensor array 110 is mounted, the distance between the sensors 500 are recorded. Measurements are also taken with a vehicle positioned in proper alignment in the target zone as part of the system set up. Further, because every space 104 is different, a start-up angle for the sensors and detection zone is also determined for monitoring approaching vehicles. The detection zone may be an automatic or manually define area that is normally clear. Sensors are set at certain angles to monitor at a particular certain height with the detection zone for approaching vehicles. Initially, the sensors may remain stationary at such angle and the panel display remains off until the sensors detect a moving vehicle. Optionally, the vehicle positioning system may be programmed such that the sensors are looking for an object with a distinctive shape (i.e., that of a vehicle) so that they do not necessarily respond to animals, people or other moving objects.

Activity detected (by RFID or similar technology) at the particular height within the detection zone triggers the system to activate, which causes the sensors to start sweeping within the designated space for the approaching vehicle. Sensors 500, through the activation of the first and second motors 502, 504 on the sensor units 300, allow the sensors 500 to sweep the area surrounding the target location to detect the angle, distance, boundaries and even speed of approaching vehicle.

The two outside sensors 500 then sweep in the left and right directions and are primarily responsible for determining the angle and distance of an approaching vehicle 102, whereas the center sensor 500 stays relatively central and forward facing, primarily responsible for measuring the distance of the vehicle 102 as it approaches the target location 105. With these data points, the system can determine the angle and distance of the approaching vehicle by taking measurements from a linear scan. The system looks for both the closest point of the approaching vehicle and its distance, as well as the point and angle where the vehicle falls out of view to determine its boundaries and overall angle and distance. Similarly, the center sensors can move up and down also determining distance and boundaries (or fall off points) of the object, which can be particular important when aligning, for example, a hopper on a cement truck, to a cleaning apparatus. By scanning up and down, the center sensor can locate the hopper and from there, the outside sensors can move up or down to align themselves linearly with the height of the hopper and commence scanning side to side again to determining boundary lines of the vehicle, which can be used to center the vehicle.

As illustrated in FIG. 9, the vehicle positioning system 100 of the present invention, in operation, performs a method of operation 900. For example, system set up is first performed 902. Then, an angle of sight and defined area for monitoring by the sensors is determined 904 (either manually or automatically). Once the sensors detect a vehicle within the defined area 906, the system turns on the panel display and commences scanning in the defined area for the angles, distance and boundaries of the approaching vehicle 910. Using information from the sensors regarding the angles, distance and boundaries of the approaching vehicle, a message is displayed on the panel display indicating the location of the vehicle and its trajectory towards the target location 912. Until the vehicle is in the target location, the sensors continue to scan in the defined area for the angles, distance and boundaries of the approaching vehicle 910, and display location information to the operator of the vehicle. Once the vehicle is in the target location 914, the system displays a message indicating that the vehicle is the target location and properly aligned 916.

One goal with the present invention is to be very intuitive with the messaging provided on panel display 130, such that individuals of all languages can understand the messaging through signals and imaging. In one example, the image gets larger as the vehicle gets closer. For example, when the vehicle is at a far distance, every pixel may represent approximate 8 inches of travel. As the vehicle gets closer to the target location, the driver will see a midsize screen where truck size on the screen is larger, and the size of the right and left trajectory lines (which form a funnel) also grow in size. At this point every pixel may represent approximately 3″ of travel. Then, as the vehicle gets even closer, the system is able to provide location information to the driver to fine tune the vehicle movements. Here, the vehicle is shown even larger and shows the trajectory lines closest to the target location as parallel lines, representing a chut for the vehicle to move within. The parallel lines, or chut, represent about the length of a standard commercial vehicle. Backing into the chut prevents the vehicle from being skewed.

Once the vehicle is right on top of the target location, every pixel represents about an inch of movement and the driver can see even the slightest movement of the vehicle change on the panel display. In summary, the scaling of the messaging changes as the truck moves closer. As the truck moves closer, different imaging is retrieved and displayed, through serial communication with the system unit, based upon information received from the sensors. As shown and described herein, the sensors allow proper placement of the vehicle on the imaging based upon the x-y coordinates of the vehicle, as determined by the sensors, which can also center the vehicle based upon the determination of the boundaries of the vehicle (or fall off points).

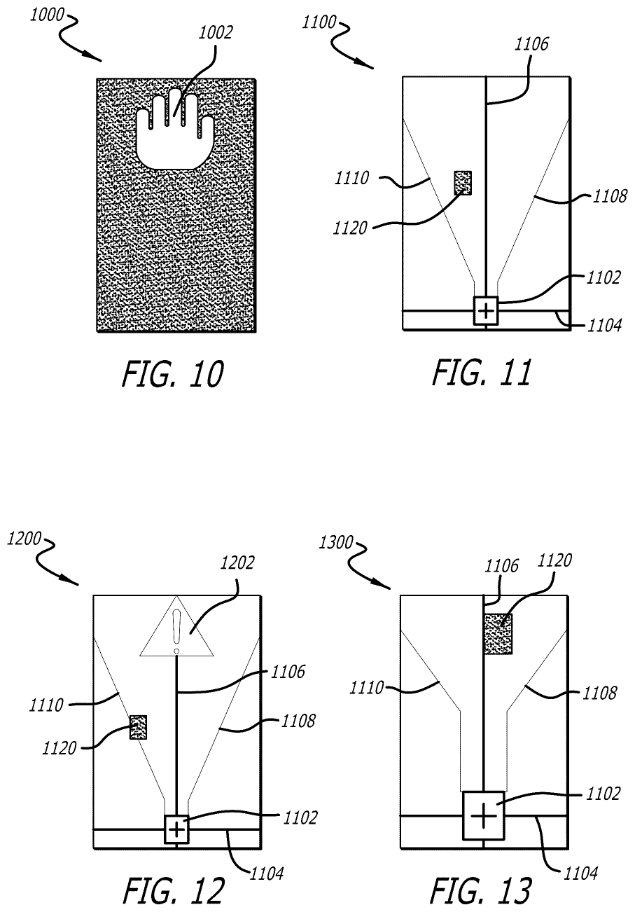

FIGS. 10-20 provide various examples of different types of messaging that may be used to assist drivers of vehicles backing into designated spaces, especially when precise alignment is required. The messaging can be either static, dynamic or a combination of both.

FIG. 10 illustrates one example of messaging 1000 that may be used with the vehicle positioning system 100 of the present invention. In this example, the screen may flash, for example in the color red, with a hand 1002 signaling for the vehicle to stop and wait before it backs into the designated space 104. This messaging 1000, may for example, be displayed when an approaching vehicle is detected but equipment is required to be set up before the vehicle can safely move into the designated space 104. The same messaging 1000 may also be used when vehicle 102 is in position and properly aligned within the target location, but should not move because and operational procedure, such as loading, unloading or cleaning, is underway or currently being performed.

FIG. 11 illustrates one example of messaging 1100 that may be used with the vehicle positioning system 100 of the present invention. Messaging 1100 shows the target location 1102 along with a base line 1104, centerline 1100 and right and left trajectory lines 1108 and 1110 along with the position of the vehicle 1120. Here, the messaging 1100 indicates that a vehicle 102, represented by box 1120, has been spotted in the far distance within range and trajectory and is cleared for approach into the designated space 104.

FIG. 12 illustrates one example of messaging 1200 that may be used with the vehicle positioning system 100 of the present invention. In this example, messaging 1200 includes a warning symbol 1202 indicates that vehicle 102 is approaching, still a far distance, but in a direction that is outside of the recommended trajectory. Here, the vehicle 1120 is still shown on the messaging 1200 at a far distance but slightly outside the trajectory line 1110. Thus, vehicle 102 will need course correction to fall within the recommended trajectory lines 1108 and 1110 to achieve proper alignment in the target location. Here, vehicle 102 may still approach but will need correction to be within the recommended trajectory to align properly with the target location 105 (as shown by box 1102 in the messaging 1200).

FIG. 13 illustrates another example of messaging 1300 that may be used with the vehicle positioning system 100 of the present invention. Messaging 1400 shows the vehicle approaching at a mid-distance range within the recommended trajectory. Here, it is also shown that the trajectory narrows into a approach path pattern once the vehicle is within a certain distance from the target 1102.

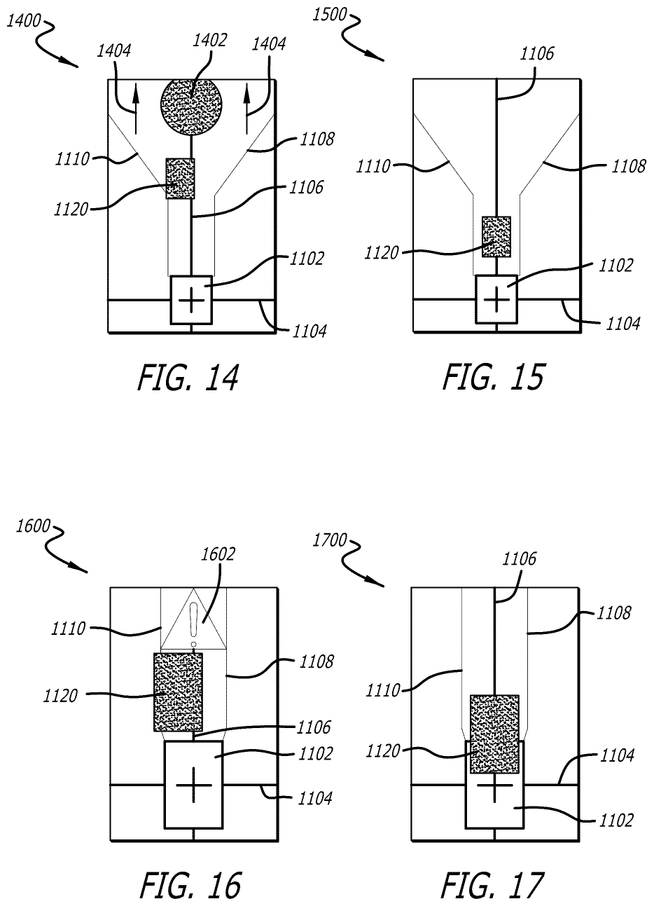

FIG. 14 illustrates yet another example of messaging 1400 that may be used with the vehicle positioning system of the present invention. Messaging 1400 shows the vehicle in mid-range and attempting to enter the approach path; however, the vehicle is entering at an unacceptable trajectory. Here, the example messaging 1400 is indicating to the driver of the vehicle 102 that the driver needs to pull forward out of the approach path and reenter the approach path with less tolerance so that the truck will not be skewed. Alignment is especially important when the procedural equipment requires more precise alignment of the vehicle in the target location. Messaging 1400 shows a stop sign 1402 and two arrows 1404 to indicate to the driver of the vehicle 102 to pull forward and realign the vehicle for his entry into the approach path.

FIG. 15 illustrates yet another example of messaging 1500 that may be used with the vehicle positioning system of the present invention. Messaging 1500 shows a vehicle approaching at range with proper approach path tolerance. Here, vehicle 1120 is centered along the centerline 1106 and within the approach path, properly aligned with the target location 1102.

FIG. 16 illustrates yet another example of messaging 1600 that may be used with the vehicle positioning system of the present invention. Messaging 1600 shows vehicle 1120 at close range but slightly out of the approach path boundary. In this example, a warning sign is displayed to the driver of the vehicle to indicate to the driver that the vehicle is outside of the recommended trajectory. The warning sign tells the driver that he still may continue to navigate the vehicle toward the target location 1102; however, some course correction may be required to properly aligned the vehicle within the approach path boundary.

FIG. 17 illustrates yet another example of messaging 1700 that may be used with the vehicle positioning system of the present invention. Messaging 1700 illustrates vehicle 1120 approaching the target at close range but in proper alignment for docketing.

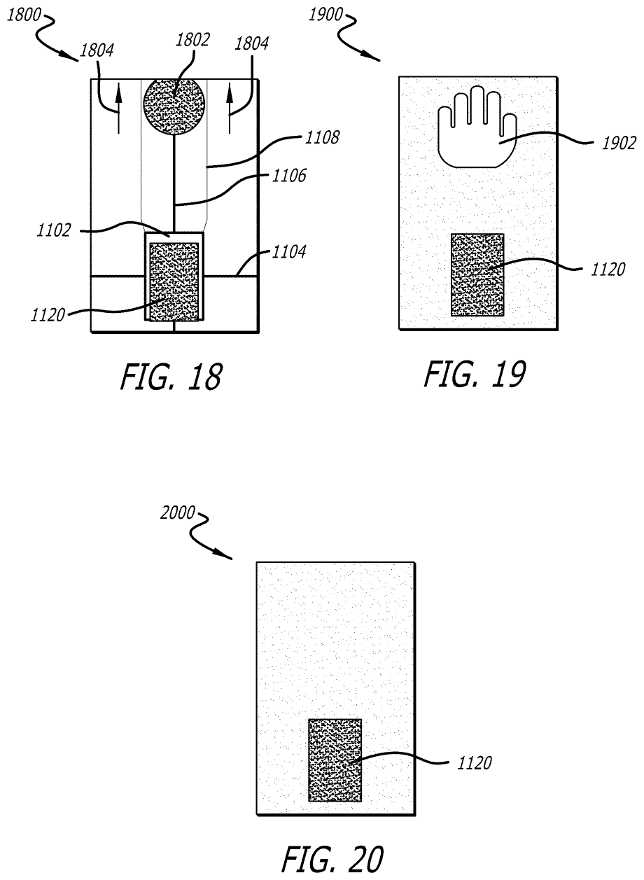

FIG. 18 illustrates yet another example of messaging 1800 that may be used with the vehicle positioning system of the present invention. Messaging 1800 illustrates that the vehicle has backed up too far within the target location 1120. Messaging includes a stop sign 1802 along with two forward arrows 1804 to indicate to the driver that he needs to pull forward and should not continue backing up.

FIG. 19 illustrates yet another example of messaging 1900 that may be used with the vehicle positioning system of the present invention. Messaging 1900 may for example include a green background that could flash while the image of vehicle 1120 remains solid, indicating that the vehicle is in proper position and should stop per the hand signal 1902.

FIG. 20 illustrates yet another example of messaging 2000 that may be used with the vehicle positioning system of the present invention. In this messaging, the background may be, for example green in color, which may indicate to the driver of the vehicle that it is safe to pull away from the designated space 104, and that the operation being performed has been completed (e.g., cleaning is completed, and any necessary interfacing equipment has been safely moved away from the vehicle).

It will be understood, and is appreciated by persons skilled in the art, that one or more processes, sub-processes, or process steps described above may be performed by hardware and/or software. If the process is performed by software, the software may reside in software memory (not shown) in a suitable electronic processing component or system such as, one or more of the functional components or modules schematically depicted in FIGS. 1-20. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It will be understood that the term “in signal communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. For example, the vehicle position system may include at least one sensor unit having at least one sensor, where the at least one sensor unit is capable of moving the at least one sensor along both the horizontal and vertical axis of the at least one sensor unit. Here, the at least one sensor unit may be programmed to perform all the functions of the array of sensors described in the previous example. Furthermore, the foregoing description is for the purpose of illustration only, and not for the purpose of limitation—the invention being defined by the claims.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

1. A vehicle position system for assisting a vehicle operator with properly aligning and positioning a vehicle within a target location, the vehicle positioning system comprising:
at least one sensor unit having at least one sensor, where the at least one sensor unit moves the at least one sensor along both the horizontal and vertical axis of the at least one sensor unit;
a panel display for displaying graphics to the vehicle operator regarding the relative position of the vehicle to the target location; and
a system unit in communication with the at least one sensor unit and the panel display for providing power to the at least one sensor unit and the panel display both, for controlling the operation of the at least one sensor unit, receiving data from the at least one sensor unit, processing the data from the at least one sensor unit for determining the relative location of the vehicle to the target location and for displaying messaging on the panel display showing the relative location of the vehicle to the target location.

2. The vehicle positioning system of claim 1, further includes a sensor array, having at least three horizontally aligned sensor units that each include a sensor.

3. The vehicle positioning system of claim 1, where graphics on the panel display include directional indications to direct the vehicle operator on the positioning of the aligning vehicle based upon data received and processed from the at least one sensor unit.

4. The vehicle positioning system of claim 1, where the graphics on the panel display include information regarding a speed of the vehicle.

5. The vehicle positioning system of claim 1, where the graphics on the panel display include information regarding a location of the vehicle.

6. The vehicle positioning system of claim 1, where the graphics on the panel display show the position of the vehicle as it moves into a particular space to allow the vehicle operator to safely and accurately reverse the vehicle into the particular space such that the vehicle is properly aligned and positioned in the target location.

7. The vehicle positioning system of claim 1, where the at least one sensor unit sweeps, tilts, remains stationary, and/or operates in any combination of movements to capture data from an area in and around the target location.

8. The vehicle positioning system of claim 7 where the captured data is processed, and the processed data generates either or both static or dynamic graphics on the panel display.

9. The vehicle positioning system of claim 8 where the graphics on the panel display includes a warning graphic to notify the vehicle operator that adjustments are required.

10. A method for assisting a vehicle operator with properly aligning a vehicle within a target location, the method comprising the steps of:
providing at least one sensor for detecting a position of an approaching vehicle;
providing a display panel for graphically showing the position of the vehicle relative to the target location;
defining a detection area for monitoring by the at least one sensor for an approaching vehicle;
defining an angle of sight for the at least one sensor to monitor for an approaching vehicle within the detection area;
activating the display panel once the at least one sensor detects an approaching vehicle with the detection area;
scanning the area around the target location with the at least one sensor to determine the angles, distance and boundaries of the approaching vehicle;
displaying a first graphical message on the display panel using the data from the at least one sensor regarding the angles, distance and boundaries of the approaching vehicle to graphically show the location of the vehicle and its trajectory relative to the target location; and
continuing to display subsequent graphical messages on the display panel until the vehicle is properly aligned in the target location.

11. The method of assisting a vehicle operator of claim 10 where displaying a first graphical message on the display panel further includes displaying a speed of the vehicle.

12. The method for assisting a vehicle operator of claim 10, where the at least one sensor is an array of sensors.

13. The method for assisting a vehicle operator of claim 12, where the array of sensors includes at least three horizontally aligned sensor units that each include a sensor.

14. The method for assisting a vehicle operator of claim 13, where the at least three horizontally aligned sensor units moves along both the horizontal and vertical axis of the at least three horizontally aligned sensor units.

15. The method for assisting a vehicle operator of claim 12, where the array of sensors includes at least three sensors capable of sweeping, tilting, remaining stationary, or operating in any combination of movements to capture data from the area in and around the target location for guiding the operator of the vehicle into the target location.

16. The method for assisting a vehicle operator of claim 10, where the first graphical message on the display panel is either or both static or dynamic.

17. The method for assisting a vehicle operator of claim 10, where the step of continuing to display subsequent graphical messages on the display panel until the vehicle is properly aligned in the target location includes adjusting the graphical messages on the display panel until the vehicle is properly positioned in the target location.

18. The method for assisting a vehicle operator of claim 10, further including the step of displaying a second graphical message if the at least one sensor detects that the position of the vehicle is too far to the driver's side or the passenger's side of the target location, where the second graphically message is a warning message.

19. The method for assisting a vehicle operator of claim 10, further including the step of displaying a second graphical message that notifies the vehicle operator to reposition the vehicle if the at least one sensor detects that the position of the vehicle has overshot the target location to direct the operator to move the vehicle forward.

20. The method for assisting a vehicle operator of claim 10, where the messages take the form of either graphics or text or a combination of both graphics and text.
